(19) United States
(12) Patent Application Publication
(10) Pub. No.: US 2002/0099808 A1
(43) Pub. Date: Jul. 25, 2002

(54) Accessing services across network security mechanisms

(76) Inventors: Ravikumar Pisupati, Milpitas, CA (US); James Sangroniz, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/768,432

(22) Filed: Jan. 24, 2001

(51) Int. Cl. G06F 15/173

(52) U.S. Cl. 709/223

(57) ABSTRACT

A device with mechanisms for accessing services across network security mechanisms. A device according to the present teachings includes a set of computing resources for providing a service which is accessible via a network and a service handler that provides access to the service in response to an email message which passes through network security mechanisms unhindered. A device according to the present teaching may be embodied in a computer system or specialized device having computing resources or in a variety of other arrangements.

### BACKGROUND OF THE INVENTION

1. Field of Invention

The present invention pertains to the field of networks. More particularly, this invention relates to accessing services across network security mechanisms.

2. Art Background

A distributed computing environment commonly includes a variety of computing elements which are interconnected via a network. Examples of computing elements include computer systems, server systems, etc., as well as specialized devices having computing resources. The computing elements of a distributed computing environment may be arranged into one or more discrete networks such as local area networks and/or organizational networks which in turn may be interconnected via larger networks such as the Internet.

One or more of the computing elements in a distributed computing environment may provide services which may be accessed via a network. An example of a service is a web page. Another example of service is a distributed application program. In many applications, it is desirable to invoke a service on a particular computing element from another computing element via a network. For example, it may be desirable to enable a technician located at a diagnostic system to invoke a diagnostic program on a remote computing element without having to physically travel to the remote site.

One prior method for invoking a service via a network is to use web protocols such as the hypertext transfer protocol (HTTP). For example, Java application programs may be invoked on a remote computing element using HTTP commands.

Prior discrete networks commonly include security mechanisms for preventing unauthorized access from outside of the discrete network. One example of such a security mechanism is a firewall. Typically, HTTP commands sent by computing elements that are not appropriately configured cannot pass through a firewall. Unfortunately, such a security mechanism can present a substantial obstacle to accessing services from outside of a discrete network.

### SUMMARY OF THE INVENTION

A device with mechanisms for accessing services across network security mechanisms is disclosed. A device according to the present teachings includes a set of computing resources for providing a service which is accessible via a network and a service handler that provides access to the service in response to an email message which passes through network security mechanisms unhindered. A device according to the present teachings may be embodied in a computer system or specialized device having computing resources or in a variety of other arrangements.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a network that incorporates the present teachings;

FIG. 2 illustrates the service handler which includes a mail handler and an HTTP server;

FIG. 3 illustrates a mail handler in one embodiment;

FIG. 4 illustrates a computing device in one embodiment.

### DETAILED DESCRIPTION

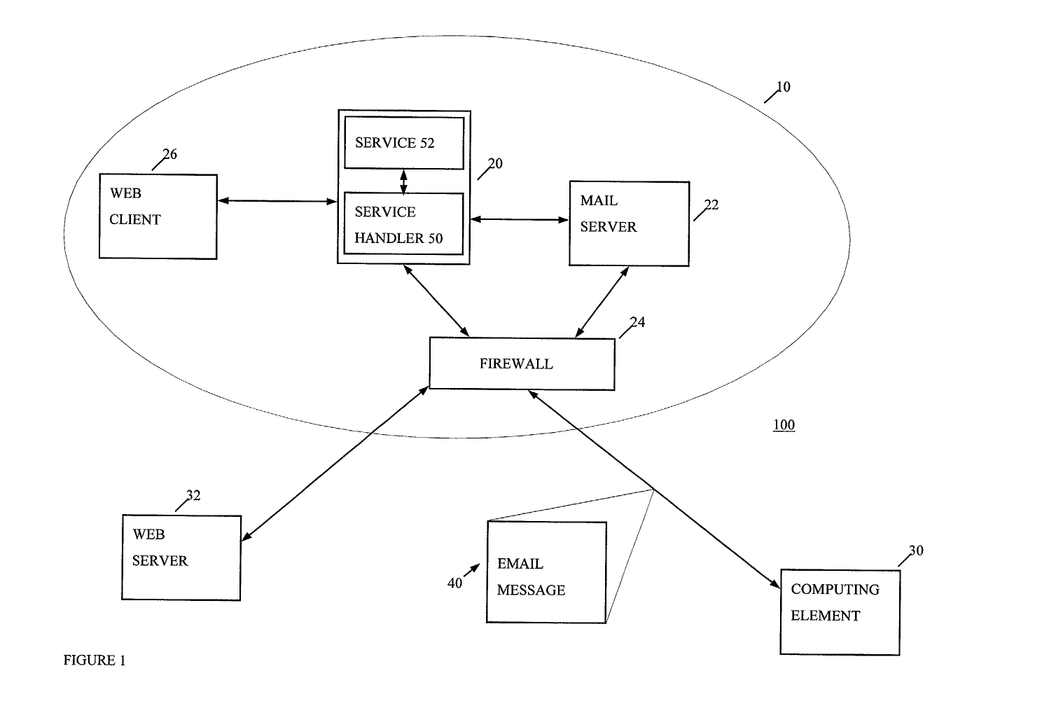

FIG. 1 shows a network 100 that incorporates the present teachings. The network 100 includes a discrete network 10 having a firewall 24 behind which is a computing element 20, a mail server 22, and a web client 26. The computing element 20 executes a service handler 50 that supports a service 52. Although only the service 52 is shown, the service handler 50 may enable access to any number of services on the computing element 20 according to the present teachings. The network 100 includes a computing element 30 that accesses the service 52 through the firewall 24.

The computing element 20 has an email address which is associated with the mail server 22 and the computing element 30 accesses the service 52 of the computing element 20 by transferring an email message 40 to the email address of the computing element 20 using standard email protocols. The email message 40 passes through the firewall 24 to the mail server 22 and the service handler 50 obtains the email message 40 from the mail server 22. The service handler 50 then performs an access function specified in the email message 40. One example of an access function specified in the email message 40 is to invoke the service 52. Another example of an access function is to provide a command to the service 52 after it is invoked.

In one embodiment, the email message 40 carries the service 52 along with a command that instructs the service handler 50 to invoke the service 52. In response, the service handler 50 extracts the service 52 and associated parameters from the email message 40 and then loads and runs the service 52 using the computing resources of the computing element 20.

In another embodiment, the email message 40 carries a URL that specifies a source from which the service 52 is to be obtained along with a command that instructs the service handler 50 to obtain and invoke the service 52 from the specified URL. In response, the service handler 50 extracts the command and associated URL from the email message 40 and then obtains the service 52 from the specified URL using HTTP protocols. For example, the specified URL may correspond to a web server 32 which stores the service 52 and the service handler 50 uses HTTP commands to obtain the service 52 from the web server 32. The service handler 50 then install and runs the service 52 using the computing resources of the computing element 20.

In yet another embodiment, the service 52 is running on the computing element 20 and the computing element 30 uses the email message 40 to send commands to the service 52. For example, if the service 52 is a diagnostic program then the email message 40 may carry commands such as start diagnostic logging, stop diagnostic logging, and return information log, etc.

A web client 26 may access the service 52 using HTTP protocols when the service 52 is running on the computing element 20. The service handler 50 generates web pages that enable the web client 26 to send commands and other information targeted for the service 52 using HTTP commands and the service handler 50 passes on the commands and information to the service 52 in response to the HTTP commands. The web pages also enable the web client 26 to obtain information from the service 52 using HTTP command and the service handler 50 obtains the information from the service 52 and passes on the information to the web client 26 in response to the HTTP commands. Alternatively, the web client 26 may access the service 52 using email messages using an appropriate mail server.

The email message 40 may include a response email address to which a response to the message 40 is to be sent. The response email address may correspond to the originator of the email message 40, the computing element 30, or some other email account. The service handler 50 sends a response message to the response email address. A response message may include status information regarding the success/failure of the command contained in the email message 40 and/or response information generated by the service 52.

The computing element 20 represents any device or system having computing resources and the appropriate hardware/software for obtaining the email message 40 from the mail server 22 and for loading and executing the service 52. Examples of the computing element 20 include computer systems, handheld devices, input/output devices, peripheral devices including storage devices, printers, scanners, etc., specialized devices such as measurement and/or actuator instruments, wireless devices, appliances, etc., to name just a few examples.

The computing element 30 represents any device or system capable of sending the email message 40 and optionally receiving a response email message from the computing element 20. Examples include computer systems and handheld communication devices.

The service 52 may be a static file or an application program or other type of program. The service 52 may be embodied in software code that is adapted to the computing resources of the computing element 20. In an embodiment in which the computing element 20 includes a Java virtual machine the service 52 may be a Java application.

In an example embodiment in which the computing element 20 is a device having computing resources, the service 52 may be an application program that performs a diagnostic function on the device. For example, the service 52 may obtain diagnostic information, possibly by invoking utilities already present on the computing element 20, and transfer the diagnostic result information back in a response email message.

The service handler 50 includes the functionality of a web server that generates one or more web pages for the computing element 20. One or more of the web pages of the computing element 20 provide links to the services running on the computing element 20. The service 52 once installed on the computing element 20 may be accessed by web clients through the web pages of the computing element 20. Web clients that may access the web pages of the computing element 20 include web clients within the network 10 and/or web clients outside of the network 10 that are configured to pass through the firewall 24.

The firewall 24 represents the appropriate hardware and software elements that function a bridge between the network 10 and elements on the network 100. The firewall 24 does not pass HTTP commands from outside the network 10 that do not have an appropriately configured IP address.

In one embodiment, the service 52 and/or the command carried in the email message 40 is authenticated with a public/private key encryption. The computing device 30 digitally signs the email message 40 using a private key. The computing element 20 possesses the corresponding public key and uses it to authenticate the email message 40 once received. In addition, the email message 40 may be encrypted by the computing device 30 and decrypted by the computing element 20.

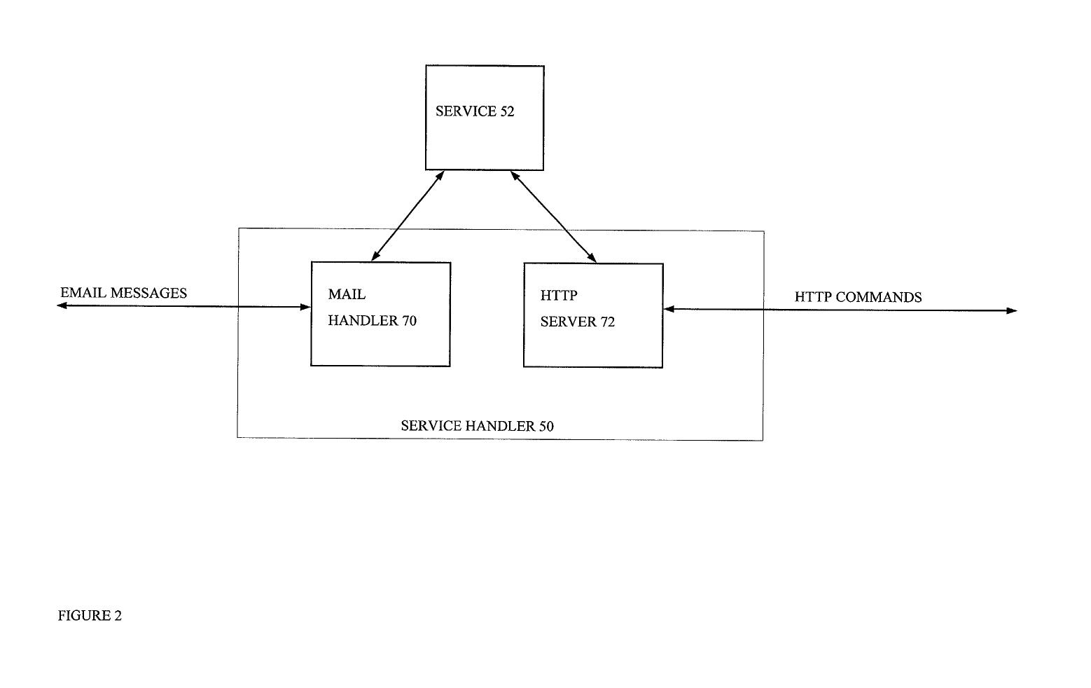

FIG. 2 illustrates the service handler 50 which includes a mail handler 70 and an HTTP server 72. In one embodiment, the device 20 includes a Java virtual machine which supports the mail handler 70 and the HTTP server 72.

The mail handler 70 obtains email messages from the mail server 22 and in response performs the appropriate access function. An example of an access function is to invoke the service 52. Another example of an access function is to provide a command to the service 52 after it is invoked. An example of a command is a command that causes the service 52 to return log data to a return email address. In one embodiment, the mail handler 70 uses public keys to verify the originators of the received email messages.

The HTTP server 72 enables web clients such as the web client 26 to access the service 52. The HTTP server 72 generates web pages associated with the computing element 20 including web pages that provide links to commands associated with the service 52.

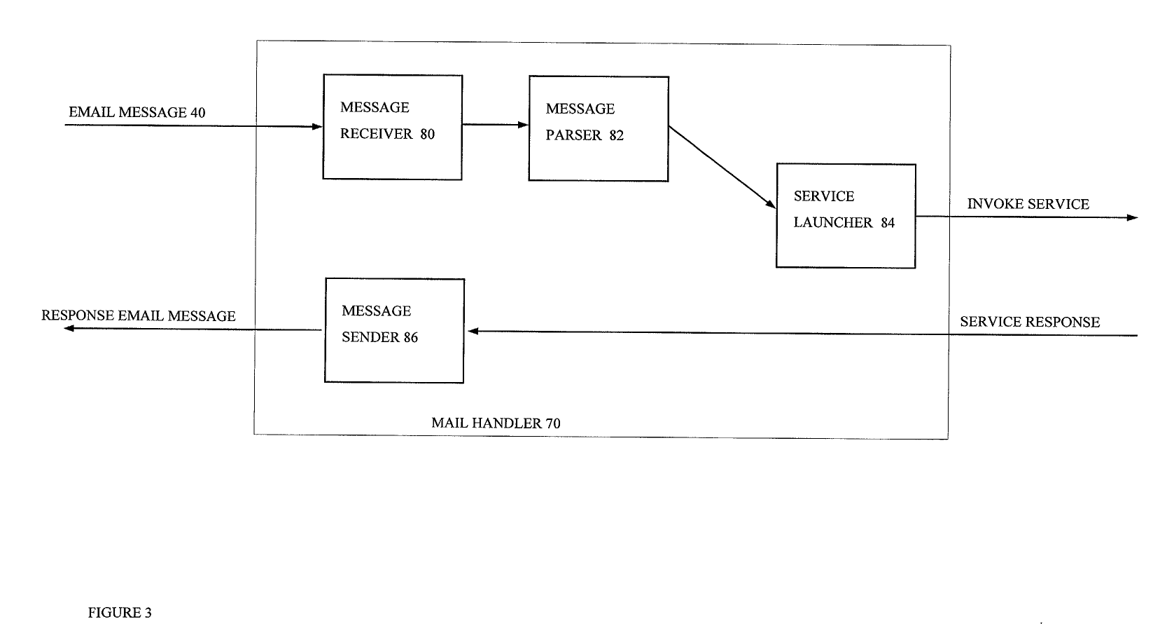

FIG. 3 illustrates the mail handler 70 in one embodiment. The mail handler 70 includes a message receiver 80 that obtains the email message 40 from the mail server 22. In one embodiment, the message receiver 80 is a POP3 email client. In another embodiment, the message receiver 80 is an SMTP message receiver. The message receiver 80 passes the email message 40 to a message parser 82. The following describes an example in which that email message 40 carries the service 52 along with a command to invoke the service 52.

The message parser 82 extracts the service 52 from the email message 40 along with the command to invoke. In response to the command to invoke, the message parser 82 passes the service 52 to the service launcher 84. The service launcher 84 invokes the service 52. In an embodiment in which the service 52 is a Java application program the service launcher 84 uses utilities provided in the underlying Java virtual machine on the device 20 to invoke the service 52.

The service 52 once it is invoked generates a service response which is passed to a message sender 86. The message sender 86 sends the service response in a response email message back to the reply email address of the email message 40. The service response may contain application-specific information.

If the email message 40 carries a command for the service 52 after it is invoked then the message parser 82 extracts the command from the email message 40 and passes the command on to the service 52. Any service response to the command is sent back to the originator of the email message 40 by the message sender 86.

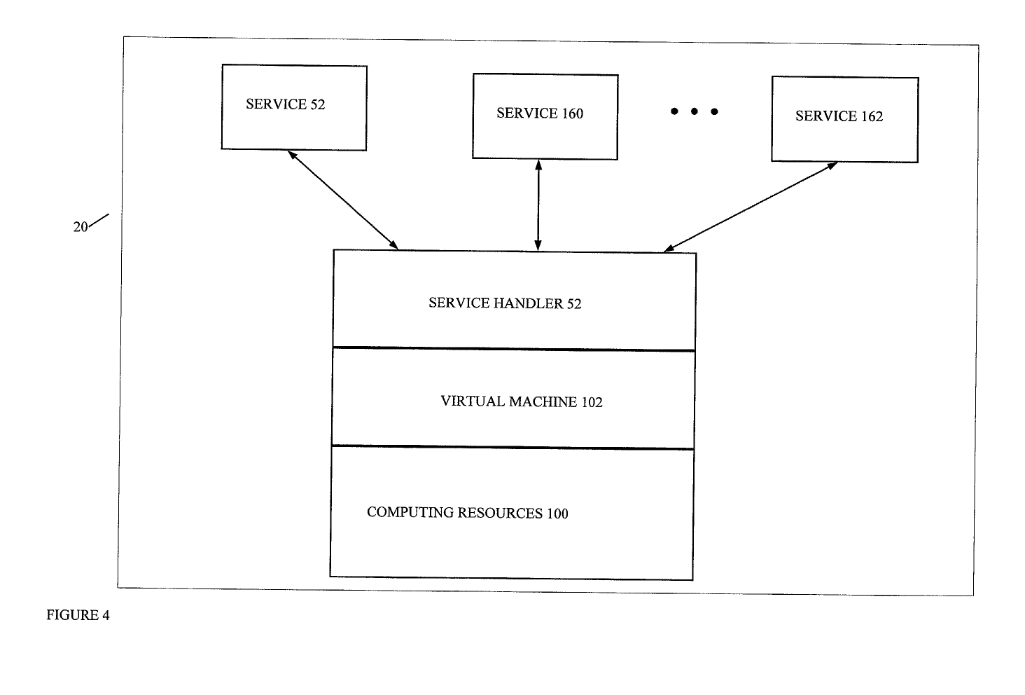

FIG. 4 illustrates the computing device 20 in one embodiment. The computing device 20 includes a set of computing resources 100 along with a set of device-specific hardware. For example, the computing resources 100 may include processor hardware, memory, storage, communication hardware, etc., as well as software support including an operating system and drivers, etc. If the computing device 20 is a printer then the device-specific hardware may include printing hardware, print memory, etc. The service 52 along with a set of services 160-162 and the service handler 52 run on top of a virtual machine 102. The virtual machine 102 includes routines for accessing hardware and for sending and receiving messages using standard mail and web protocols.

In one embodiment, the service 52 is a diagnostic service that logs data associated with the device-specific hardware in the device 20. The computing element 30 may send a command in an email message to cause the service 52 to start logging data and later send a command to stop logging data and then send a command that causes the service 52 to return the logged data. Alternatively, the web client 26 may invoke these same commands using links provided on a web page generated by the service handler 50.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A device, comprising:
a set of computing resources for providing a service which is accessible via a network;
service handler that provides access to the service in response to an email message.

2. The device of claim 1, wherein the email message carries the service and an invoke command such that the service handler loads and runs the service using the computing resources in response to the invoke command.

3. The device of claim 1, wherein the email message carries a URL for the service and an invoke command such that the service handler obtains the service from the URL and then loads and runs the service using the computing resources in response to the invoke command.

4. The device of claim 1, wherein the email message includes a command associated with the service such that the service handler passes the command to the service in response to the email message.

5. The device of claim 1, wherein the service handler enables access to the service in response to an HTTP command.

6. The device of claim 1, wherein the service is a diagnostic service for the device.

7. A communication system, comprising:
device having a set of computing resources for providing a service and having a service handler that provides access to the service via a network;
firewall that controls access to the device from outside of the network;
computing element that accesses the service through the firewall by transferring an email message to the service handler using an email message.

8. The communication system of claim 7, further comprising a computing element that accesses the service by transferring an HTTP command to the service handler via the network.

9. The communication system of claim 8, wherein the HTTP command includes a command associated with the service such that the service handler passes the command to the service in response to the HTTP command.

10. The communication system of claim 7, wherein the email message carries the service and an invoke command such that the service handler loads and runs the service using the computing resources in response to the invoke command.

11. The communication system of claim 7, wherein the email message carries a URL for the service and an invoke command such that the service handler obtains the service from the URL and then loads and runs the service using the computing resources in response to the invoke command.

12. The communication system of claim 7, wherein the email message includes a command associated with the service such that the service handler passes the command to the service in response to the email message.

13. The communication system of claim 7, wherein the service is a diagnostic service for the device.

14. A method for accessing a service in a device, comprising the steps of:
transferring an email message to the device via a network;
accessing the service in response to the email message.

15. The method of claim 14, further comprising the steps of:
transferring an HTTP command to the device via the network;
accessing the service in response to the HTTP command.

16. The method of claim 14, wherein the email message carries the service and an invoke command.

17. The method of claim 16, further comprising the steps of loading and running the service using a set of computing resources in the device in response to the invoke command.

18. The method of claim 14, wherein the email message carries a URL for the service and an invoke command.

19. The method of claim 18, further comprising the steps of obtaining the service from the URL and then loading and running the service using a set of computing resources in the device in response to the invoke command.

20. The method of claim 14, wherein the email message includes a command associated with the service.

21. The method of claim 20, further comprising the step of passing the command to the service in response to the email message.
